(19) United States
(12) Patent Application Publication
(10) Pub. No.: US 2022/0365921 A1
(43) Pub. Date: Nov. 17, 2022

(54) Verifiable Cacheable Calclulations

(71) Applicant: Intuit Inc., Mountain View, CA (US)

(72) Inventors: Glenn Carter Scott, Los Altos Hills, CA (US); Michael Richard Gabriel, Milpitas, CA (US); Roger C. Meike, Mountain View, CA (US); Lalla Mouatadid, Ontario (CA)

(73) Assignee: Intuit Inc., Mountain View, CA (US)

(21) Appl. No.: 17/246,401

(22) Filed: Apr. 30, 2021

(51) Int. Cl. G06F 16/23; G06F 16/22; G06F 16/2455; G06F 12/0875

(52) U.S. Cl. CPC G06F 16/2365; G06F 16/2255; G06F 16/2456; G06F 12/0875; G06F 2212/163

(57) ABSTRACT

A method implements verifiable cacheable calculations. A result is calculated. The result is hashed to generate a name of the result. The result is an input of a set of inputs from which the name is generated. Each input of the set of inputs identifies one of a data set, a query, and a function. The result is stored in a cache using the name generated from hashing the result. A request is received to access the result using the name. The result is retrieved from the cache using the name generated from hashing the result corresponding to the input. The result is presented in response to the request.

### BACKGROUND

In today's information driven economy, an enterprise may collect large amounts of data. The data is used to compute derivative information and generate semantic meaning from events and values. For example, a computation may calculate the mean profit for all companies using a financial services provider in the first quarter of 2020. As another example, the standard deviation in the minimum temperature of freezers in a chain of grocery stores may be computed. Additionally, machine learning may use vast data sets for training.

Many computations are repeated again and again, which is wasteful. Additionally, the input data may be “live,” meaning that the values within data sets may change over time. With changing values, computations on the same data set will change each time it is recomputed. This creates an issue when stable values are needed to reproduce or verify certain results. Multiple copies of the input data may be made that remains fixed in time but this is also wasteful, difficult to manage, and hard to verify. A challenge is to verify and reuse calculations in a scalable fashion without wasting resources.

### SUMMARY

In general, in one or more aspects, the disclosure relates to a method that implements verifiable cacheable calculations. A result is calculated. The result is hashed to generate a name of the result. The result is an input of a set of inputs from which the name is generated. Each input of the set of inputs identifies one of a data set, a query, and a function. The result is stored in a cache using the name generated from hashing the result. A request is received to access the result using the name. The result is retrieved from the cache using the name generated from hashing the result corresponding to the input. The result is presented in response to the request.

In general, in one or more aspects, the disclosure relates to a system that includes a server with one or more processors and one or more memories. An application, executing on the one or more processors of the server, is configured to implement verifiable cacheable calculations. A result is calculated by a result generator of the application. The result is hashed, by the result generator, to generate a name of the result. The result is an input of a set of inputs from which the name is generated. Each input of the set of inputs identifies one of a data set, a query, and a function. The result is stored in a cache of the server using the name generated from hashing the result. A request is received, by the application, to access the result using the name. The result is retrieved from the cache using the name generated from hashing the result corresponding to the input. The result is presented in response to the request.

In general, in one or more aspects, the disclosure relates to a method using verifiable cacheable calculations. A request is transmitted to access a result using a name. The result is calculated in response to a previous request. The result is hashed to generate the name. The result is an input of a set of inputs from which the name is generated. Each input of the set of inputs identifies one of a data set, a query, and a function. The result is stored in a cache using the name generated from hashing the result. In response to the request, the result is retrieved from the cache using the name generated from hashing the result. The result is received in response to the request.

Other aspects of the invention will be apparent from the following description and the appended claims.

### BRIEF DESCRIPTION OF DRAWINGS

FIG. 1A and FIG. 1B show diagrams of systems in accordance with disclosed embodiments.

FIG. 2 shows a flowchart in accordance with disclosed embodiments.

FIG. 3A, FIG. 3B, FIG. 3C, FIG. 4A, FIG. 4B, FIG. 5A, FIG. 5B, FIG. 6A, and FIG. 6B show examples in accordance with disclosed embodiments.

FIG. 7A and FIG. 7B show computing systems in accordance with disclosed embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure verify and reuse calculations in a scalable fashion without wasting resources. In the context of web services, a web application may use the same calculations to generate different web pages shown to different clients. Instead of redoing the calculations each time for each page for each client, embodiments of the invention perform the calculations a first time, generate a name from a hash of the calculation, and store the calculations in a cache using the name. For subsequent pages that use the same calculations, the embodiments may retrieve the calculations from the cache using the name without having to redo the calculations and reduce the computational resources needed to generate and transmit the page.

Additionally, for machine learning applications, the same initial calculations may be performed on the same training data as part of training a machine learning model. Embodiments of the disclosure may retrieve cached versions of the initial calculations instead of recalculating the initial calculations every time a machine learning model is trained and used, which reduces the computational resources needed to train and use machine learning models and applications.

To reduce the waste of repetitive calculations, an expression, e.g., “M(Q(db))” can be computed once and the result (“R”) cached for reuse, which is addressable by a unique name. A data set is a set of data that may be stored in a database or saved in a cache and may be the results of a query or of a function.

“db” represents a data set within a database, which may include business accounting data for multiple companies with transactions over the lifespan of each company.

“Q(·)” represents a database query that, when applied to db, produces a query result (a data set), which, for example, may be contain the profit of each company.

“M(·)” represents a function that returns the result “R” (a data set), which, for example, may be a calculation of a mean profit from the individual or periodic profits of a set of companies.

The database, db, is the input into query Q(·) (represented by the expression “Q(db)”), which is then input into the mean function, M(·) (represented by the expression “M(Q(db))”), giving the result, R, as shown Equation 1 below.

R=M(Q(db)) Eq. 1

Embodiments of the disclosure assign a unique name to R and subsequent computations may refer to R using the name, rather than recomputing the value of R again. Furthermore, the name of the result R may represent the actual data set output by calculating M(Q(db)), which may include one or multiple values in any number of dimensions. If db, M, or Q change, the computed result R will also change and a different corresponding name will be assigned to the output. In Equations 2-4 below, the data sets db₁ and db₂ are different yielding results R₁ and R₂ that are also different and which would have different unique names.

db₁≠db₂ Eq. 2

M(Q(db₁))→R₁≢M(Q(db₂))→R₂ Eq. 3

R₁≠R₂ Eq. 4

A name refers to either an immutable data set or an expression. Examples of immutable data sets include a data set in a database, the data set of a query result, and the data set of the function result. Examples of expressions include queries (e.g., the query represented by the expression “Q(db)”), functions, and sequences of queries and functions (e.g., the expression “M(Q(db))”).

In the case where a name refers to an immutable data set (e.g., the data set represented by the expression “db”), the data is fetched and may be returned. In the case where a name refers to an expression (e.g., “M(Q(db))”), if a result for the name does not exist, then the expression is evaluated and the result cached with its corresponding name.

A name is a unique label for the data and the operations used to perform calculations. A hash may be used to derive a unique name in addition to other techniques. For example, additional techniques include a digital signature, an administratively assigned name, and so forth.

In one embodiment, a name of a data set is a hash computed from different inputs. For example, a 256-bit hash of an entire raw data set is an adequate name to uniquely distinguish the raw data set. For brevity in this disclosure, a 256-bit hash is represented by an abbreviation, e.g., a 256-bit hash value “56674b93766d3262080cf7fc62c7459987f43eb41640b0bf5ce14b0f93069aa1” may be represented by the abbreviation “5667 . . . 9aa1”. In one embodiment, the name may be appended to a domain name to generate a uniform resource identifier (URI) from which the data set associated with the name may be retrieved.

The hash function used to generate the hash value may be a cryptographic hash function implementing an algorithm to map data of arbitrary size (also known as a “message”) to a bit array of a fixed size (also known as a “hash value”, a “hash”, or a “message digest”). The hash function is a one-way function that is practically infeasible to invert, i.e., to generate the input from the output. Examples of hash functions that may be used include MD5 (message digest 5), SHA (secure hash algorithm), RIPEMD (RACE integrity primitives evaluation message digest), Whirlpool, BLAKE, etc.

Equation 5 below computation of the hash value for a name is represented by the below. Where “A, B, C, . . . ” denotes the inputs to the name derivation function “F” and N is the resulting name. As an example, the input “A” may identify the data set represented by “db”, the input “B” may identify the query “Q(·)”, the input “C” may identify the query result of “Q(db)”, etc. The inputs may also include metadata about the data sets, queries, and functions. For example, an input may include a timestamp that indicates the date and time a data set was generated.

F:A,B,C, . . . =N Eq. 5

In one embodiment, the name derivation function “F” generates a single 256-bit hash value by hashing all of the inputs. For example, with the inputs “db, Q(db)”, the name derivation function “F” may hash the data set of “db” concatenated with and the query result of “Q(db)” to generate the name “42E . . . 45F”.

In another embodiment, the name derivation function “F” appends hash values for each of the inputs to generate the name. For example, with the inputs “db, Q(db)”, the name derivation function “F” appends the hash value for “db” (“1E0 . . . 8EC”) with the hash value for “Q(db)” (“55D . . . 17F”) with a separator (e.g., “/”) to generate the name “1E0 . . . 8EC/55D . . . 17F”.

Expressions identify data sets (e.g., “db”) and sequences of calculations (e.g., “M(Q(db))”) to perform on data sets. As expressions are evaluated, partial and final results are generated that are cached for future use. For example, to evaluate the expression “M(Q(db))”:

the data set “db” is retrieved from network attached storage and stored to the cache with the unique name “1E0 . . . 8EC”;

the query “Q(db)” or “Q(‘1E0 . . . 8EC’)” is calculated to form a partial result stored in the cache with the unique name “55D . . . 17F”; and

the function “M(Q(db))” or “M(‘55D . . . 17F’)” is calculated to for a final result stored in the cache with the unique name “F26 . . . 3A1”.

In one embodiment, data sets (including results) are named with a “raw name” computed from directly hashing the content of the data set without taking into account the expressions used to compute the data set. With a raw name, the evaluation of the two expressions x² and x̅⁴ produce identical results (identical data sets) event though their computations are different and, hence, may have identical names.

In one embodiment, chained names are used that provide for data provenance. Data provenance in a name shows the sequence of calculations. For example, for the expression M(Q(db)), the inputs to the name derivation function may include:

| Input | Value | Description |
|---|---|---|
| db | 59A . . . 3ED | A hash value generated from the data set db |
| Q | C58 . . . 53B | An identifier for the query Q (e.g., a hash |
| | | value of the query string) |
| Q(db) | 55D . . . 17F | A hash value generated from the query |
| | | result of Q applied to db |
| M | 0BB . . . EC2 | An identifier for the function M (e.g., a |
| | | hash value generated from the code for M |
| | | or from a memory address for M) |
| M(Q(db)) | F26 . . . 3A1 | A hash value generated from the function |
| | | M applied to the query result Q(db) |

The output from the name derivation function from the above inputs may be the name
“59A . . . 3ED/C58 . . . 53B/55D . . . 17F/F26 . . . 3A1/F26 . . . 3A1”.

In one embodiment, signed chained names are used in which the names of the data sets, queries, functions, and results may be digitally signed. The digital signature may be performed with a cryptographic algorithm, examples of which include RSA (Rivest-Shamir-Adleman), DSA (digital signature algorithm), ECDSA (elliptic curve digital signature algorithm), etc. As an example, with the expression M(Q(db)), the data forming the query result Q(db) and the function result M(Q(db)) may each be signed with a private key. Signing the data allows subsequent proof that the signor of the data set generated the data set. The data set may be signed and then hashed to form the name or vice versa, i.e., the data is hashed, which is then signed. As an example, for the expression M(Q(db)), the inputs to the name derivation function may include:

| Input | Value | Description |
|---|---|---|
| db | 59A . . . 3ED | A hash value generated from the |
| | | data set db |
| Q | C58 . . . 53B | An identifier for the query Q |
| | | (e.g., a hash value of the |
| | | query string) |
| signature(Q(db)) | 83B . . . 0BE | A hash value generated from the |
| | | signed query result of Q applied |
| | | to db |
| M | 0BB . . . EC2 | An identifier for the function M |
| | | (e.g., a hash value generated |
| | | from the code for M or from a |
| | | memory address for M) |
| signature(M(Q(db))) | 5D6 . . . 2A1 | A signed hash value generated |
| | | from the function M applied to |
| | | the query result Q(db) |

The output from the name derivation function from the above inputs may be the name
“59A . . . 3ED/C58 . . . 53B/83B . . . 0BE/F26 . . . 3A1/5D6 . . . 2A1”.

In one embodiment, computable chained names are used in which partial or final results are not included in the name. Computable chained names enable computing the expected name of a final result by starting with the name of data set (e.g., “db”) and computing the desired name. For example, for the expression M(Q(db)), the expressions Q(db) and M(Q(db)) may not be included in the set of inputs and are not used by the name derivation function. The inputs may include:

| Input | Value | Description |
|---|---|---|
| db | 59A . . . 3ED | A hash value generated from the data set db |
| Q | C58 . . . 53B | An identifier for the query Q (e.g., a hash |
| | | value of the query string) |
| M | 0BB . . . EC2 | An identifier for the function M (e.g., a hash |
| | | value generated from the code for M or from |
| | | a memory address for M) |

The output from the name derivation function from the above inputs may be the name
“59A . . . 3ED/C58 . . . 53B/0BB . . . EC2”.

In one embodiment, collapsing subexpressions are used to generate a name. With collapsing subexpressions, only certain data sets are cached. For example, for the expression M(Q(db)), the inputs to the name derivation function may include:

| Input | Value | Description |
|---|---|---|
| db | 59A . . . 3ED | A hash value generated from the data set db |
| M(Q(•)) | AD3 . . . 43D | A hash value generated from the function M |
| | | applied to the query Q (without specifying the |
| | | data set) (e.g., a hash value of the query string |
| | | concatenated with the code for the function) |

The output from the name derivation function from the above inputs may be the name
“59A . . . 3ED/AD3 . . . 43D”.

The subexpressions are evaluated but the partial results are not saved. When evaluating M(Q(db))), a name of db and of M(Q(·)) are computed. The name of the final result includes the full name of db and the hash of the M(Q(·)) function. This generalizes to any collection of operations where the hash of Mₖ( . . . (M₂(M₁(Q(·)))) . . . ) is computed once only for all data sets. Formally, let M={M₁, . . . , Mₖ} be a collection of functions, and [symbol] a function-operator precedence on M. For every valid permutation σ=ƒ₁(ƒ₂( . . . (·) . . . )), ƒᵢ∈M of operations in [symbol] ordering, compute the hash of σ once for all queries Q(db).

In one embodiment, graphs may be used to generate names. Let G=(V, E, L) be a rooted directed acyclic graph where V, E, L are the sets of vertices, edges, and vertex labels respectively. For every v∈V:L(v) is the computed name of the operations leading to v. A directed edge (a, b) is added whenever the child node b is a result of an operation applied to its parent a.

Formally, the label of the root r of G is the name of the data set (db), i.e., the hash of the raw data set: L(r)=hash(db).

For every new query Q on db, a new vertex v is added to V with a corresponding edge (r, v) and label L(v)=L(r)+hash(Q).

For every new operation M on Q(db), a new vertex u is introduced with edge (v, u) and label L(u)=L(v)+hash(Q).

For any chained operations Mₖ( . . . (M₂(M₁(Q(db)))) . . . ), there is a directed path from the root of G to a node vₖ of the form P=r, u, v₁, v₂, . . . , vₖ where:
u has L(u)=L(r)+hash(Q) and corresponds to the computation Q(db));
v₁ has L(v₁)=L(u)+hash(M₁) and corresponds to the computation M₁(Q(db));
. . . ;
vᵢ has L(vᵢ)=L(vᵢ₋₁)+hash(Mᵢ) and corresponds to the computation of Mᵢ(Mᵢ₋₁( . . . (db) . . . )).

If a new operation is performed, its corresponding node and label are added to G. If an existing chain of operations already exists, it suffices to traverse the graph and return the label of the final node in the path of computations.

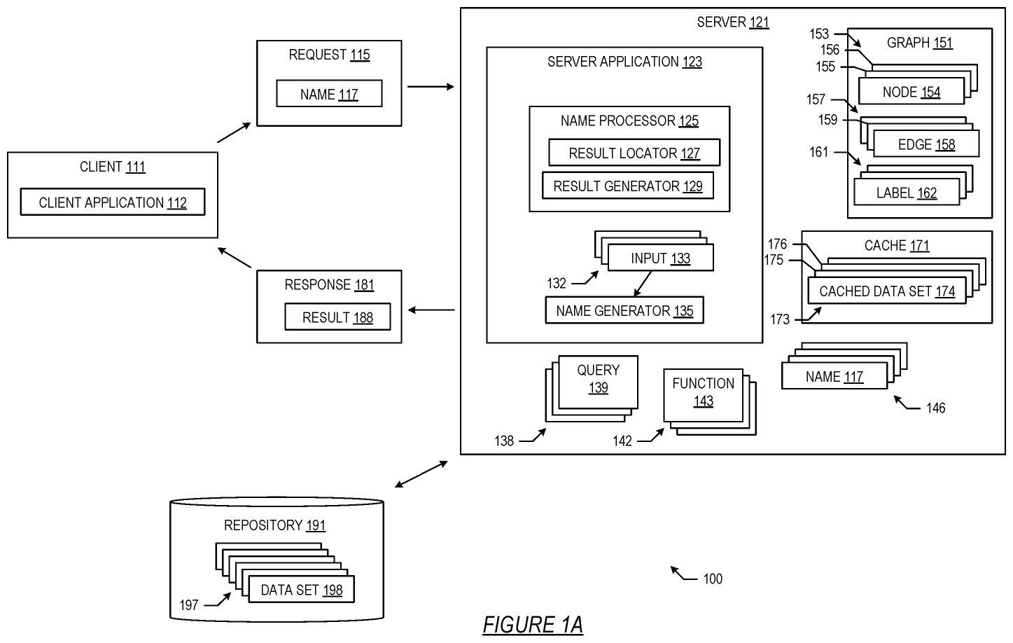

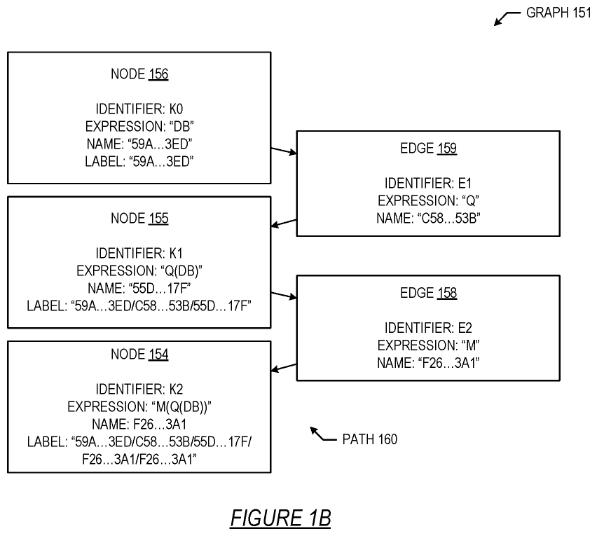

FIGS. 1A and 1B show diagrams of embodiments that are in accordance with the disclosure. FIG. 1A shows a system (100) that implements verifiable cacheable calculations. FIG. 1B shows a path of a graph of the system (100). The embodiments of FIGS. 1A and 1B may be combined and may include or be included within the features and embodiments described in the other figures of the application. The features and elements of FIGS. 1A and 1B are, individually and as a combination, improvements to verifiable cache technology and computing systems. The various elements, systems, and components shown in FIGS. 1A and 1B may be omitted, repeated, combined, and/or altered as shown from FIGS. 1A and 1B. Accordingly, the scope of the present disclosure should not be considered limited to the specific arrangements shown in FIGS. 1A and 1B.

Turning to FIG. 1A, the system (100) implements verifiable cacheable calculations to reuse calculations used by web services and by systems that train machine learning models. The client (111) sends the request (115) to the server (121) and, in return, receives the response (181). The server (121) processes the request (115) to generate the response (181) using the name (117) (from the request (115)) to locate or generate the result (188) (provided in the response (181)). If the name (117) identifies cached data located in the cache (171) (e.g., one of the cached data sets (173)), then the cached data is provided as the result (188) in the response (181). If the name (117) does not identify data located in the cache (171), then the server application (123) evaluates the expression identified by the name (117) (which is enumerated by the graph (151)) to generate the result (188), stores the result (188) to the cache (171) (e.g., as the cached data set (174)) using one of the names (146) generated from the result (188). In one example, evaluating the expression identified by the name (117) may include retrieving the data set (198) from the repository (191) (which may then be saved to the cache (171)), applying the query (139) to the data set (198) to generate a query result (which may then be saved to the cache (171)), and applying the function (143) to the query result to generate the result (188), which may be saved to the cache (171), e.g., as the cached data set (174).

The server application (123) is a set of programs executing on the server (121) to interact with the client (111) and the repository (191). The server application (123) processes the name (117) from the request (115) with the name processor (125) and generates names used by the system with the name generator (135).

The name processor (125) is a set of programs of the server application (123) that processes the names from requests, including the name (117) from the request (115). The name processor (125) includes the result locator (127) and the result generator (129).

The result locator (127) is a program of the name processor (125) that locates data in the cache (171). The result locator (127) may receive the name (117) as an input and output a data set corresponding to the name from the cache or a code indicating that the cache does not include a data set that corresponds to the name (117). In one embodiment, the result locator (127) uses a mapping between the names (146) and the cached data sets (173) to determine if the cache (171) includes a data set corresponding to the name (117) and responsive to the request (115). In one embodiment, the result locator (127) may determine if the cache (171) includes a corresponding cached data set for each data set, query, or function that corresponds to the name (117). For example, the name (117) may identify the expression “M(Q(db))” and the result locator (127) may determine which, if any, of the cached data sets (173) correspond to the data set for the expression “db”, the data set for the partial result for the expression “Q(db)”, and the data set for the final result for the expression “M(Q(db))”.

The result generator (129) is a program of the name processor (125) that generates results by evaluating expressions from names, such as the name (117). For example, if the result locator (127) indicates that the cache (171) does not include any of the data sets, partial results, or final results for the name of the expression “M(Q(db))”, the result generator (129) may retrieve data sets, generate partial and final results, and store data sets (including results) to the cache (171). For the expression “db”, the result generator (129) may retrieve the data set (198) from the repository (191) and store the data set (198) as the cached data set (176) in the cache (171). For the expression “Q(db)”, the result generator (129) may apply the query (139) (corresponding to the expression “Q(·)”) to the data set (198) (or equivalently to the cached data set (176)) to generate a query result, and save the query result (a partial result) to the cache (171) as the cached data set (175). For the expression “M(Q(db))”, the result generator (129) may apply the function (143) (corresponding to the expression “M(·)”) to the cached data set (175) (the partial result generated from the expression “Q(db)”) to generate a result, and store the result to the cache (171) as the cached data set (174).

Continuing with FIG. 1B, the name generator (135) is a program of the name processor (125) that generates the names (146) used by the system (100). For example, the name generator (135) may generate the name (117) from the inputs (132). Each of the inputs (132) may identify expressions, data sets, results, queries, functions, metadata, etc. In one embodiment, the name generator (135) generates a name for each of the inputs (132) and joins the names with a separator. For example, the inputs (132) may be encoded as a structured text string (e.g., JavaScript object notation (JSON)):

```
{
  “db”: {
    “name”: “5d54b17e9f119e9976f294f86b32c563
      a03707a549d464dfc8e309cb80aa268a”,
    “version”: “8”,
    “last update”: “00:00:00 UTC on 1 January 2021”
  },
  “Q”: {
    “name”: “9f8659a608a1b505e353cdb824b74e6a
      8fa07d610803be19d359d2633ff5b3d5”,
    “version”: “1”,
  },
  “Q(db)”: “ ”
}
```

The first input “db” (which may correspond to the data set (198)) has the name “5d5 . . . 68a”, is version 8, and was last updated on March 28. The name may be used to locate “db” in the cache (171) and may be a hash value generated by applying a hash function to the data from the data set (198).

The second input “Q” (which may correspond to the query (139)) has the name “9f8 . . . 3d5” and is version 1. The name may be used to identify the query (139) and may be a hash value generated by applying a hash function to the query (139) (e.g., to the query string conforming to a query language, e.g., structured query language (SQL)).

The third input “Q(db)” indicates that the previous two inputs are to be combined to generate the result. For example, the result generator may generate a result for “Q(db)” that is saved to the cache (171) as the cached data set (175). The third input does not include a name. A name, generated by the name generator (135) from the inputs (132), may be included in the response (181) with the result (188) so that future requests may utilize the name generated with the name generator (135).

The queries (138), including the query (139), are data query language requests for information retrieval with database and information systems. Different query languages may be used in the queries (138) by the system (100) to access the data sets (197) of the repository (191). As an example, the query (139) may identify the data set (198), which may be filtered version of a larger data set.

The functions (142), including the function (143), are programs that process data accessible to the system (100), e.g., the data sets (197). Each function may perform one or multiple operations onto a data set. For example, one function may calculate the mean of a data set and another function may calculate the squares of the values within the data set. As another example, a function may perform an algorithm of a machine learning model, e.g., a neural network model. The function may perform the forward pass or backward pass of the neural network model on a data set from the repository (191) to generate a result that may be stored back to the repository (191) and to the cache (171).

Still referring to FIG. 1A, the names (146), including the name (117), reference and may correspond to the cached data sets (173) stored in the cache (171), the queries (138), the functions (142), the data sets (197) in the repository, as well as sequences of that may include multiple ones of the data sets (197), the queries (138), the functions (142), and the cached data sets (173). The names (146) may be generated with the name generator (135) and returned with responses, including the response (181). For example, for the expression “M(Q(db))” received in the request (115) and identified with the name (117), names returned in the response (188) may include: a name for the data set corresponding to the expression “db”, a name for the query corresponding to the expression “Q(·)”, a name for the query result corresponding to the result generated from evaluating the expression “Q(db)”, a name for the function corresponding to the expression “M(·)”, a name for the result corresponding to the result generated from evaluating the expression “M(Q(db))”, etc.

The names (146) may be mapped to memory addresses of the cache (171) that correspond to the cached data sets (173). As an example, the name (117) may be mapped to the cached data set (174), which may be generated by the result generator (129) to form the result (188).

The cache (171) stores the cached data sets (173). In one embodiment, the cache (171) is a data store of the server (121) implemented with non-persistent storage, e.g., random access memory (RAM).

The cached data sets (173), including the cached data set (174), are cached versions (i.e., copies) of data sets and results retrieved and generated by the server (121). Each of the cached data sets may be identified by at least one of the names (146). As an example, the cached data set (174) may be identified by the name (117).

The graph (151) is a data structure maintained by the server (121). The graph (151) may track the cached data sets (173) in the cache (171) and enumerate the data sets, queriers, functions, and sequences thereof that may be processed by the system (100). The graph (151) may be traversed by the name generator (135) to construct the names (146) from paths formed by the nodes (153) and the edges (157) (see the path (160) of FIG. 1B).

The nodes (153), including the nodes (154), (155), and (156), represent data sets used by the system. A node may identify data sets in the repository (191) and in the cache (171). For example, the node (156) may represent the data set (198) (in the repository (191)) corresponding to the expression “db” and to the cached data set (176) (in the cache (171)). The node (155) may represent the cached data set (175), which may correspond to the result obtained from evaluating the expression “Q(db)”. The node (154) may represent the cached data set (174), which may correspond to the result obtained from evaluating the expression “M(Q(db))”.

The edges (157), including the edge (158) and (159), connect the nodes (153) of the graph (151). The edges (157) identify the queries or functions used to generate a child node from a parent node. For example, the edge (159) may identify the query (139) as the query used to generate the child node (155) (representing “Q(db)”) from the parent node (156) (representing (“db”). The edge (158) may identify the function (143) as the function used to generate the child node (154) (representing “M(Q(db))”) from the parent node (155) (representing “Q(db)”).

The labels (161), including the label (162), may correspond to the names generated from the paths of the graph (151) that identify the nodes of the graph (151). For example, the label (162) may identify the path from node (156) to node (155) through the node (155) using the edges (158) and (159). In one embodiment the label (162) may be correspond to the node (154) and the name (117).

The request (115) is a message, generated by the client (111), requesting data and is serviced by the server (121). The request includes the name (117) that identifies the result (188) (in the response (181)). The request (115) may be generated by the client application (112) in response to user interaction with the client (111).

The response (181) is a message, generated by the server (121), responsive to the request (115) and received by the client (111). The response includes the result (188) that corresponds to the data set identified in the name (117).

The client application (112), operating on the client (111), interacts with the server (121) to request and present information of the system (100) stored in the repository (191) and in the cache (171). In one embodiment, the client application (112) may be a web browser that accesses the applications running on the server (121) using web pages hosted by the server (121). In one embodiment, the client application (112) may be a web service that communicates with the applications running on the server (121) using representational state transfer application programming interfaces (RESTful APIs). Although FIG. 1A shows a client server architecture, one or more parts of the training application (114) and the server application (103) may be local applications on the client (111) without departing from the scope of the disclosure.

The client application (112) may include multiple interfaces (e.g., graphical user interfaces) for interacting with the system (100). A user may operate the client application (112) to perform tasks that retrieve and write information from and to the data sets (197) in the repository (191).

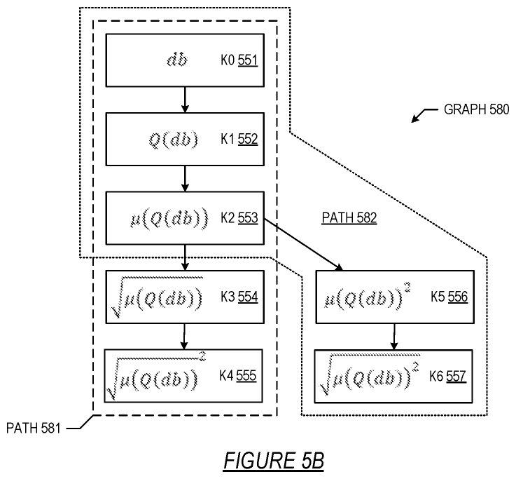

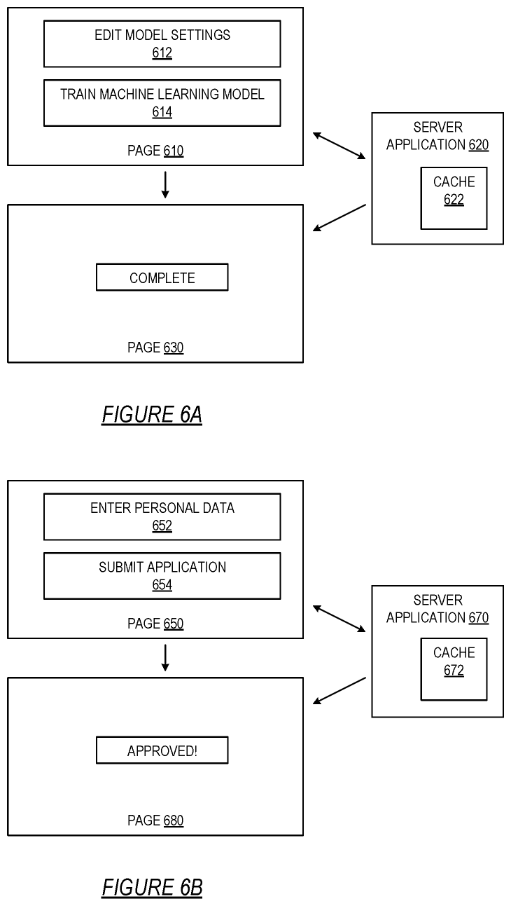

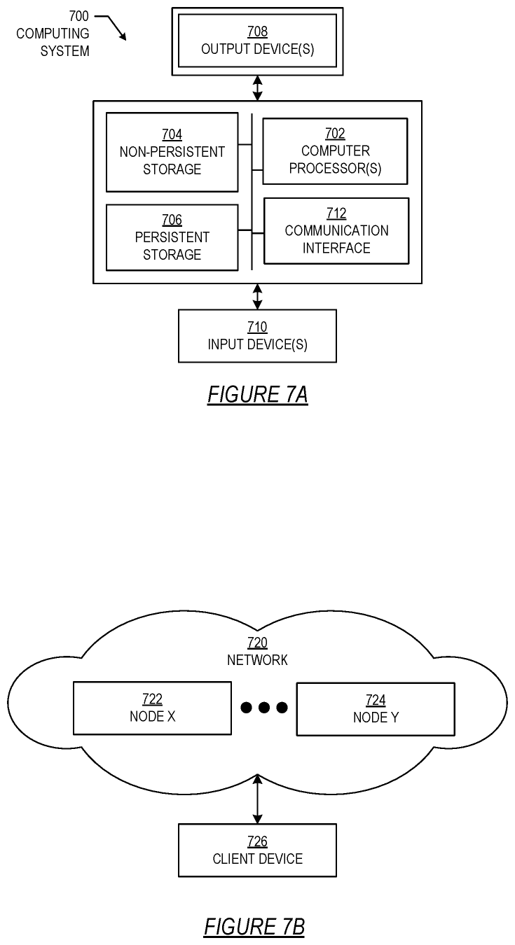

The server (121) uses the server application (123), the cache (171), the queries (138), the functions (142), the names (146), and the graph (151) to process requests from clients (including the request (115)) and generate responses (including the response (181)). The server (102) executes the server application (123) that communicates with the client (111) and the repository (191). The server (102) receives and responds to requests from the client (111) and stores data to the repository (191) in response to interactions with the client (111). Each of the programs running on the server (102) may execute inside one or more containers hosted by the server (102). The server (121) may be one of multiple servers hosted by a cloud environment to service requests from multiple clients, including the client (111). The server (102) may be one of a set of virtual machines hosted by a cloud services provider to deploy the server application (123). The server (121) may be embodied as a computing system as described in FIG. 7A.

The client (111) may be a device (or process executing on a device) that interacts with the server (121) by sending and receiving messages, including the request (115) and the response (181). The messages may be sent and received as part of a representational state transfer application programming interface (RESTful API) using hypertext transfer protocol (HTTP) messages that include text formatted in accordance with JavaScript object notation. Other protocols and standards for communication and data serialization may be used, including remote procedure calls (RPC), protocol buffers (Protobuf), etc. The client (111) may be embodied as a computing system as described in FIG. 7A.

The repository (191) is a computing system that may include multiple computing devices in accordance with the computing system (700) and the nodes (722) and (724) described below in FIGS. 7A and 7B. The repository (191) may be hosted by a cloud services provider. The cloud services provider may provide hosting, virtualization, and data storage services as well as other cloud services and to operate and control the data, programs, and applications that store and retrieve data from the repository (191). The data in the repository (191) includes the data sets (197), which include the data set (198). Some of the data sets (197) may be cached in the cache (171) by the server (121) to reduce the access time to the underlying data.

Turning to FIG. 1B, the graph (151) includes the path (160). The path (160) is formed from the nodes (156), (155), and (154) with the edges (159) and (158).

Each of the nodes (156), (155), and (154) includes an identifier, represents an expression, and may be referenced by a name and a label. The names may be generated from hashing the underlying data set represented by the node. The labels may be generated from the path identified between a start node and an end node.

The node (156) is identified by the identifier k₀, represents the expression “db”, and is referenced by the name “59A . . . 3ED”, which also serves as the label for the node (156). The node (155) is identified by the identifier k₁, represents the expression “Q(db)”, and is referenced by the name “55D . . . 17F”, and is referenced by the label “59A . . . 3ED/C58 . . . 53B/55D . . . 17F” (having a corresponding sequence of expressions of “db/Q/Q(db)”. The node (154) is identified by the identifier k₂, represents the expression “M(Q(db))”, and is referenced by the name “F26 . . . 3A1”, and is referenced by the label “59A . . . 3ED/C58 . . . 53B/55D . . . 17F/F26 . . . 3A1/F26 . . . 3A1” (having a corresponding sequence of expressions of “db/Q/Q(db)/M/M(Q(db))”.

Each of the edges (159) and (158) includes an identifier, represents an expression (e.g., a query or a function), and is referenced by a name. The edge (159) is identified by the identifier e₁, represents the expression “Q”, and is reference by the name “C58 . . . 53B” corresponding to the query (139). The edge (158) is identified by the identifier e₂, represents the expression “M”, and is reference by the name “C58 . . . 53B” corresponding to the function (143).

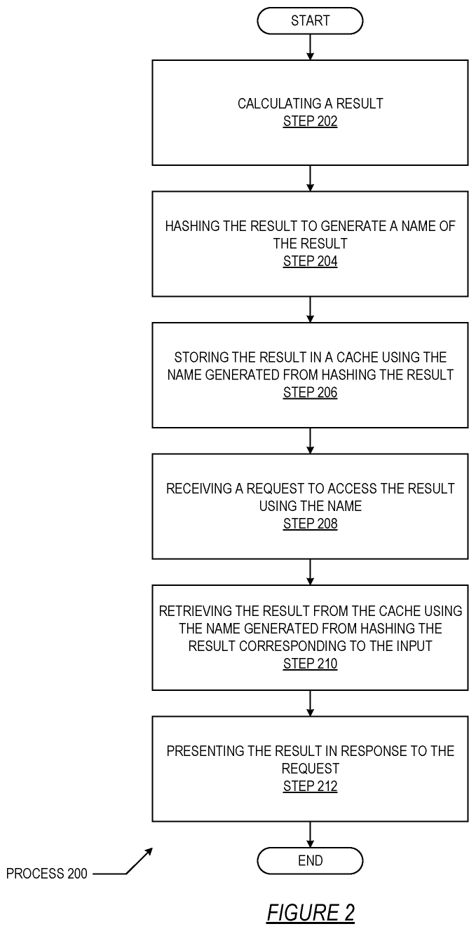

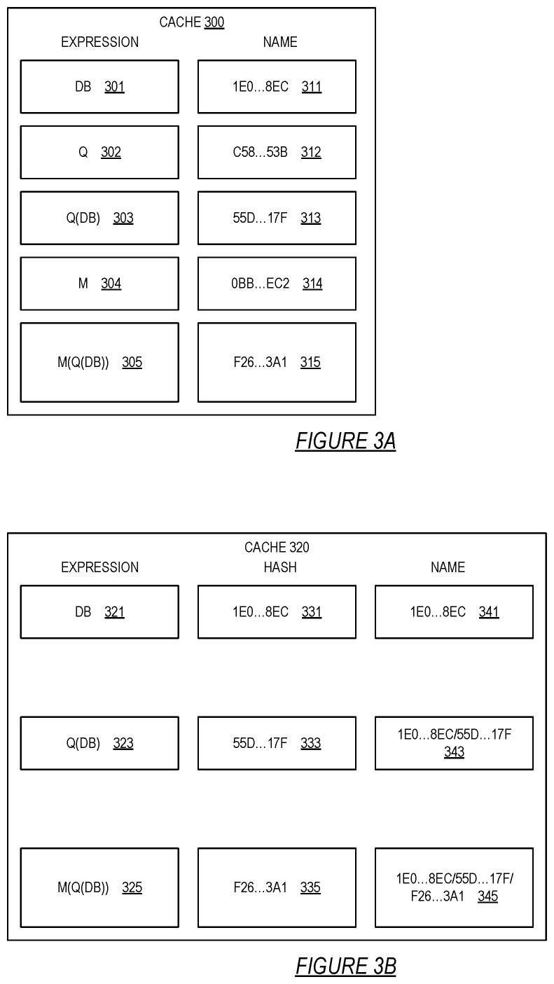

FIG. 2 shows flowcharts of processes in accordance with the disclosure. FIG. 2 is a flowchart of a method of a class for servicing update messages. The embodiments of FIG. 2 may be combined and may include or be included within the features and embodiments described in the other figures of the application. The features of FIG. 2 are, individually and as an ordered combination, improvements to verifiable cache technology and computing systems. While the various steps in the flowcharts are presented and described sequentially, one of ordinary skill will appreciate that at least some of the steps may be executed in different orders, may be combined or omitted, and at least some of the steps may be executed in parallel. Furthermore, the steps may be performed actively or passively. For example, some steps may be performed using polling or be interrupt driven. By way of an example, determination steps may not have a processor process an instruction unless an interrupt is received to signify that condition exists. As another example, determinations may be performed by performing a test, such as checking a data value to test whether the value is consistent with the tested condition.

Continuing with FIG. 2, the process (200) implements verifiable cacheable calculations to reuse calculations used by web services and by systems that train machine learning models. The process (200) may be performed by an application executing on a server.

At Step 202, a result is calculated. In one embodiment, an initial request to access the result is receiving before calculating the result. The result may be calculated by evaluating an expression corresponding to an initial name (which may resolve to an expression instead of to a data set), which is included in the initial request. For example, the expression “M(Q(db))” may be identified in the initial name in the initial request. After generating the result in response to the initial request, the result is presented and may include the name identifying the data set (as opposed to the initial name identifying the expression) for future reference to the result.

In one embodiment, a request may specify the set of inputs that include a data set, a query, and a function. For example, the request may correspond to the string of expressions “db/Q(db)/M(Q(db))”. To evaluate the expression, the data set (e.g., “db”), identified by a first input of the set of inputs is located in a repository. The query (e.g., “Q”), identified by a second input of the set of inputs, is applied to the data set (“db”) to generate the query result (“Q(db)”), which is also referred to as a partial result. The function (e.g., “M”), identified by a third input of the set of inputs, is applied to the query result (“Q(db)”, i.e., the partial result) to generate the final result (“M(Q(db))”).

At Step 204, the result is hashed to generate a name of the result. For example, the result of evaluating the expression “M(Q(db))” may be hashed to generate the name.

In one embodiment, the result may be an input of a set of inputs from which the name is generated. For example, the set of inputs may correspond to the string of expressions “db/Q(db)/M(Q(db))”, which includes the expression “M(Q(db))”, which evaluates to the result that was calculated.

In one embodiment, each input of the set of inputs may identify one of a data set, a query, and a function. A data set is a set of data. Data from a data set of a repository, query results, partial results, and final results may each be a “data set” that is specified by an input of the set of inputs. The set of inputs may include one or more inputs. Each of the inputs may be a data set, a query, or a function. Any number or combination of data sets, queries, and functions may be included in a set of inputs. For example, one set of inputs may include a data set; another set of inputs may include a data set and a function; another set of inputs may include multiple data sets, multiple queries, and multiple functions.

In one embodiment, the set of inputs is hashed to generate the name from the set of inputs. For example, the request may correspond to the string of expressions “db/Q(db)/M(Q(db))”. Instead of hashing each result individually, the data sets and results may be appended and then hashed. In one embodiment, each result may be individually hashed, the individual hash concatenated, and the concatenated hashes may be hashed again to generate a single hash value.

In one embodiment, multiple hashes may be appended together to generate the name. A first input from the set of inputs is hashed to generate a first hash value. A second input from the set of inputs is hashed to generate a second hash value. The first hash value is joined with the second hash value to generate the name. For example, for the request corresponding to the string of expressions “db/Q(db)”, the first input “db” is hashed to generate the hash value “59A . . . 3ED. The second input “Q(db)” is hashed to generate the hash value “55D . . . 17F”. The two hash values are joined with the separator “/” to create the name “59A . . . 3ED/55D . . . 17F”.

In one embodiment, the result may be digitally signed to generate the name. For example, the result corresponding the to the expression “M(Q(db))” may be signed with the private key of a user. Subsequent users may then verify the corresponding data set using the public key of the user. In one embodiment, the hash of the result is signed to reduce the amount of processing resources used to sign the result.

In one embodiment, a name may be generated that does not include hashes of data sets (e.g., does not include hashes of partial results, final results, the initial data set, etc.). In one embodiment, a subset of the set of inputs may be hashed without hashing a result included in the set of inputs to generate a computable name of the function corresponding to an input of the subset of the set of inputs.

As an example, the name from a request corresponding to the string of expressions “db/Q(db)/M(Q(db))” may be processed so that a hash of the query (“Q”) and a hash of the function (“M”) are included in the name (referred to as a computable name) without including hashes of the data sets (i.e., “db”, “Q(db)”, or “M(Q(db))”). The hashes of the query and the function may be appended with a separator to generate the computable name “C58 . . . 53B/0BB . . . EC2” (corresponding the to the chained expression “Q/M”). This name may then be used to generate a result, for example by applying the function (“M”) using the computable name to generate a result.

In one embodiment, some of the data sets (including results and partial results) are included in the name. A set of inputs, including a first input corresponding to either the result or a partial result, are hashed to generate the name without converting the other of the result or the partial result. For example, for a request specifying the string of expressions “db/Q(db)/M(Q(db))”, the resulting name may include hash values for the string of expressions “Q/M/M(Q(db))” (i.e., “C58 . . . 53B/0BB . . . EC2/F26 . . . 3A1”) which includes the hash value for the result “M(Q(db))” but does not include the hash value for the partial result “Q(db)” or of the initial data set “db”.

At Step 206, the result is stored in a cache using the name generated from hashing the result. The result may also be stored to the repository.

At Step 208, a request is received to access the result using the name. In one embodiment, the name may be generated by the client. In one embodiment, the name may have been included in a previous response to a previous request.

At Step 210, the result is retrieved from the cache using the name generated from hashing the result corresponding to the input. In one embodiment a mapping from the name to the memory address in the cache for the cached data corresponding to the result is used to locate the result in the cache.

At Step 212, the result is presented in response to the request. For example, the result may be presented by transmitting the result from the server to the client and then by the client displaying the result to a user.

In one embodiment, graphs may be used to generate the names. A graph is traversed to identify a path corresponding to the set of inputs. Each node of the graph may correspond to one of a data set, a partial result, and a result. The graph is directed and acyclic and includes an edge that identifies a function (e.g., “M”) applied to a first node, of the graph, to generate the result (e.g., “M(Q(db))”) corresponding to a second node of the graph. The name of the result is then generated using the path. For example, the hash values (names) for each node (and edge) may be appended with separator characters to form the final name, also referred to as a label for the second node.

In one embodiment, graphs may include different paths to the same result. A graph is traversed to identify a first path. The first path corresponds to the set of inputs and to the result. The first path is different from a second path that corresponds to the result and does not correspond to the set of inputs. The result in the cache may be accessed using the first path or the second path.

In one embodiment, nodes may be added to graphs in response to requests for data sets that have not been cached. A node corresponding to one of a result and a partial result may be added to a graph after calculating the result or partial result and storing the result or partial result in the cache. The new node is either a child of a previous calculation or a new query/function on the data. Multiple nodes may also be added. For example, if M(Q(db)) is new (i.e., neither M(·) nor Q(·) have been used before), then two new nodes may be added to the graph, one for the partial result Q(db)) and one for the result M(Q(db)).

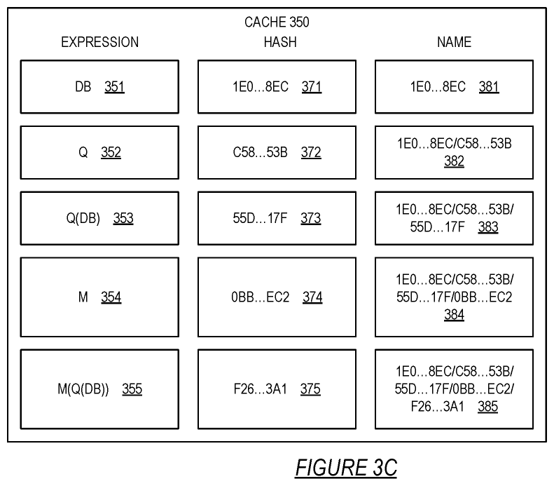

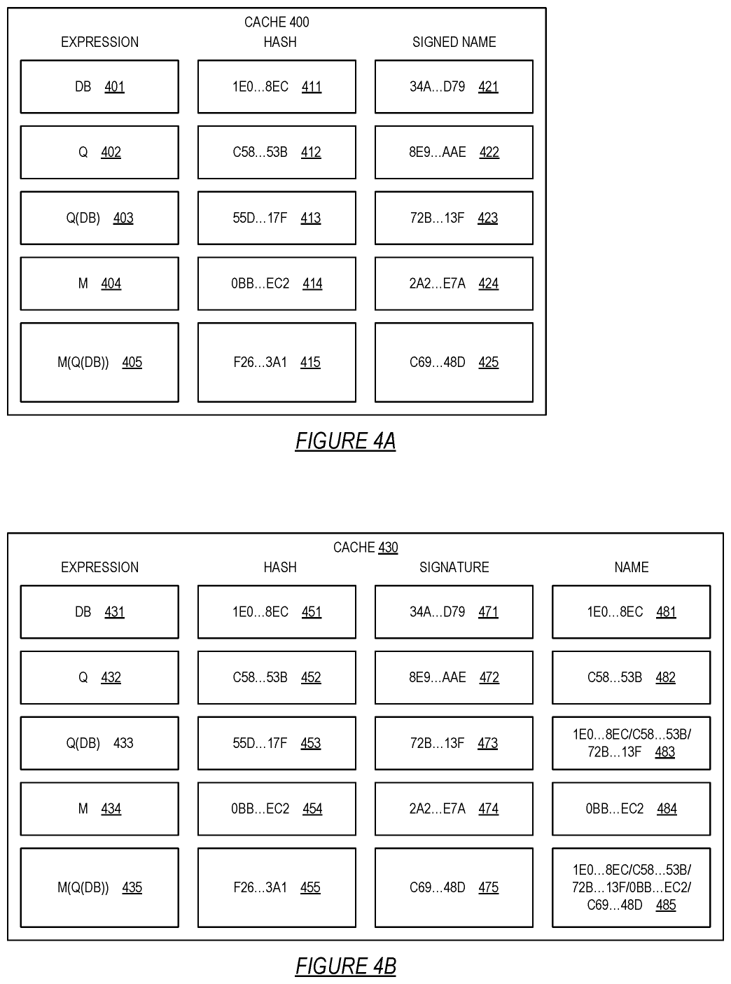

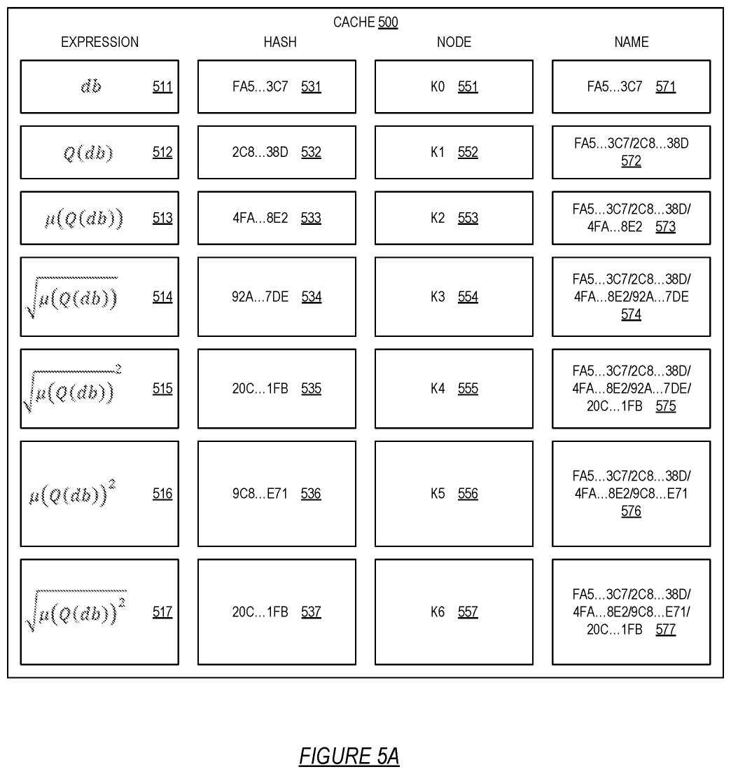

FIGS. 3A, 3B, 3C, 4A, 4B, 5A, 5B, 6A, and 6B show examples of systems and sequences that secure hash chains in accordance with the disclosure. FIGS. 3A, 3B, and 3C show caches that use hash values in names to reference data sets. FIGS. 4A and 4B show caches that use hash values and signatures in names to reference data sets. FIGS. 5A and 5B show caches that use hash values and graphs. FIG. 6A shows a system using a verifiable cache to train machine learning models. FIG. 6B shows a system using a verifiable cache to process applications. The embodiments shown in FIGS. 3A, 3B, 3C, 4A, 4B, 5A, 5B, 6A, and 6B may be combined and may include or be included within the features and embodiments described in the other figures of the application. The features and elements of FIGS. 3A, 3B, 3C, 4A, 4B, 5A, 5B, 6A, and 6B are, individually and as a combination, improvements to verifiable cache technology and computing systems. The various features, elements, widgets, components, and interfaces shown in FIGS. 3A, 3B, 3C, 4A, 4B, 5A, 5B, 6A, and 6B may be omitted, repeated, combined, and/or altered as shown. Accordingly, the scope of the present disclosure should not be considered limited to the specific arrangements shown in FIGS. 3A, 3B, 3C, 4A, 4B, 5A, 5B, 6A, and 6B.

Turning to FIG. 3A, the cache (300) references data sets and functions (including queries) using single hash values for the names. The data sets and functions may be used by web services and displayed in web pages to clients and may also be used by machine learning models to generate predictions and the train the machine learning models. Using the data sets form the cache (300) reduces the computations resources needed for web services, machine learning, etc. The expression (301) identifies the data set “db” in a database. The expression (302) identifies the query “Q” (which may also be referred to as a function). The expression (303) applies the query “Q” to the database “db”. The expression (304) identifies the function “M”. The expression (305) applies the function “M” to the result from expression (303).

The expressions (301), (302), (203), (304), and (305) are referenced with the names (311), (312), (313), (314), and (315), respectively. The names (311), (313), and (315) are the hash values generated from the data sets generated from evaluating the expressions (301), (303), and (305). The names (312) and (314) are hash values generated from hashing the code for the functions (302) and (304).

Turning to FIG. 3B, the cache (320) uses chained names to reference data sets. The data sets corresponding to the expressions (321), (323) and (325) are accessed with the names (341), (343), and (345), respectively. The names are generated by appending the hash values together. For example, the name (345) may be generated by appending the hashes (331), (333), and (335) together with a separator character (“/”).

Turning to FIG. 3C, the cache (350) uses chained names to reference data sets and functions. The data sets and functions corresponding to the expressions (351), (352), (353), (354), and (355) are respectively accessed with the names (381), (382), (383), (384), and (385). The names are generated by appending the hash values together. For example, the name (345) may be generated by appending the hashes (371), (372), (373), (374), and (375) together with a separator character (“/”).

Turning to FIG. 4A, the cache (400) references data sets and functions (including queries) using signed hash values for the names. The expressions (401), (402), (403), (404), and (405) are referenced with the signed names (421), (422), (424), (424), and (425), respectively. In one embodiment, the signed names (421), (422), (423), and (425) digitally signed versions of the hash values (411), (412), (413), (414), and (415), respectively. The hash values (411), (413), and (415) are the hash values generated from the data sets generated from evaluating the expressions (401), (403), and (405). The names (412) and (414) are hash values generated from hashing the code for the functions (402) and (404).

Turning to FIG. 4B, the cache (430) references data sets and functions using signed hash values for the names. The expressions (431), (432), (433), (434), and (435) are referenced with the names (481), (482), (484), (484), and (485), respectively, which may include multiple signatures. For example, the name (485), includes the hash (451), the hash (452), the signature (473), the hash (454), and the signature (455). In one embodiment, the signatures (471), (472), (473), and (475) digitally signed versions of the hash values (451), (452), (453), (454), and (455), respectively. The hash values (451), (453), and (455) are the hash values generated from the data sets generated from evaluating the expressions (431), (433), and (435). The names (452) and (454) are hash values generated from hashing the code for the functions (432) and (434).

Turning to FIG. 5A, the cache (500) references data sets with names in a system that uses graphs. The expressions (511), (512), (513), (514), (515), (516), and (517) are referenced by the names (571), (572), (573), (574), (575), (576), and (577), respectively. The names (571), (572), (573), (574), (575), (576), and (577) are generated from joining certain hash values. For example, the name (575) (corresponding to the path (581) of FIG. 5B) is created by appending the hash values (531), (532), (533), (534), and (535) with a separator (“/”). The name (577) (corresponding to the path (582) of FIG. 5B) is created by appending the hash values (531), (532), (533), (536), and (537) with a separator (“/I”). The nodes (551), (552), (553), (554), (555), (556), and (557) are identified respectively with the identifiers k₀, k₁, k₂, k₃, k₄, k₅, and k₆. The expression (511) identifies the data set “db” in a database. The expression (512) applies the query “Q” to the data set “db”. The expression (513) applies the function “μ” (mean) to the query result from expression (512). The expression (514) takes the square root of the expression (513). The expression (515) squares the expression (514). The expression (516) squares the expression (513). The expression (517) takes the square root of the expression (516).

The expression (516) and (517) may effectively be equivalent expression the generate the same result leading to the hash values (535) and (537) being the same. By having the same result, the accuracy of the first result may be double checked with the second result.

Turning to FIG. 5B, the graph (580) includes the nodes (551), (552), (553), (554), (555), (556), and (557). The nodes (551), (552), (553), (554), and (555) form the path (581) and the nodes (551), (552), (553), (556), and (557) form the path (582). The two paths (581) and (582) yield the same result using a different order of operations allowing the results from both paths to be checked against each other.

Turning to FIG. 6A, a user is developing a machine learning model that executes on a cloud computing service. The user accesses the page (610) and selects the button (612) to edit the settings of the model. For example, the user may change the number of layers of a neural network. After adjusting the model, the user may then train the machine learning model by selecting the button (614). In response to selection of the button (614), the server application (620) receives a request to execute the functions that apply the machine learning model to a data set. The request may include the expressions “MLM(db)”, which applies the machine learning model (“MLM”) to the data set (“db”).

The data set (“db”) has not changed and is retrieved from the cache (622).

Since the model (“MLM”), and the functions that make up the model, have changed, the output from the model is updated and then stored to the cache (622) using the name corresponding to the expression string “db/MLM/MLM(db)”. Additionally, the result (“MLM(db)”) is signed so that other users may verify the results. After the model is trained, the server application (620) sends the page (630) to the client device indicating that the training is complete. Using the cached data sets and calculations reduces the training time for the machine learning model.

Turning to FIG. 6B, a user is requesting a loan using an online application submission process hosted through a financial services website. The user accesses the page (650) and selects the button (652) to enter personal data for the loan application. In response to selection of the button (654), the server application (670) receives a request to process the loan application by applying queries and functions to data pertinent to the loan application. The request may include the expressions “AP(Q(db))”, which applies a query (“Q”) to the database (“db”) to pull information based on the user's personal data. The application processing function (“AP”) is then applied to the query result.

The server application (670) retrieves the data set (“db”), applies the query (“Q”) to the data set to generate a partial result (“Q(db)”) that is stored in the cache (672). The server application (670) applies the function (“AP”) to the partial result to generate the final result (“AP(Q(db))”). After generating the final result, the server application successfully sends the page (680) to the client device of the user which indicates that the loan corresponding to the loan application is approved. Using the cached data sets and calculations reduces the time to generate and transmit web pages, including the page (680).

Embodiments of the invention may be implemented on a computing system. Any combination of a mobile, a desktop, a server, a router, a switch, an embedded device, or other types of hardware may be used. For example, as shown in FIG. 7A, the computing system (700) may include one or more computer processor(s) (702), non-persistent storage (704) (e.g., volatile memory, such as a random access memory (RAM), cache memory), persistent storage (706) (e.g., a hard disk, an optical drive such as a compact disk (CD) drive or a digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) (702) may be one or more cores or micro-cores of a processor. The computing system (700) may also include one or more input device(s) (710), such as a touchscreen, a keyboard, a mouse, a microphone, a touchpad, an electronic pen, or any other type of input device.

The communication interface (712) may include an integrated circuit for connecting the computing system (700) to a network (not shown) (e.g., a local area network (LAN), a wide area network (WAN) such as the Internet, a mobile network, or any other type of network) and/or to another device, such as another computing device.

Further, the computing system (700) may include one or more output device(s) (708), such as a screen (e.g., a liquid crystal display (LCD), a plasma display, a touchscreen, a cathode ray tube (CRT) monitor, a projector, or other display device), a printer, an external storage, or any other output device. One or more of the output device(s) (708) may be the same or different from the input device(s) (710). The input and output device(s) (710 and (708)) may be locally or remotely connected to the computer processor(s) (702), non-persistent storage (704), and persistent storage (706). Many different types of computing systems exist, and the aforementioned input and output device(s) (710 and (708)) may take other forms.

Software instructions in the form of computer readable program code to perform embodiments of the invention may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system (700) shown in FIG. 7A, or a group of nodes combined may correspond to the computing system (700) shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system (700) shown in FIG. 7A. Further, the client device (726) may include and/or perform all or a portion of one or more embodiments of the invention.

The computing system (700) or group of computing systems described in FIGS. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system (700) in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system (700) of FIG. 7A, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (700) in FIG. 7A may implement and/or be connected to a data repository. For example, one type of data repository is a database. A database is a collection of information configured for ease of data retrieval, modification, re-organization, and deletion. A Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g., join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (700) of FIG. 7A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system (700) of FIG. 7A and the nodes (e.g., node X (722), node Y (724)) and/or client device (726) in FIG. 7B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
calculating a result;
hashing the result to generate a name of the result,
wherein the result is an input of a set of inputs from which the name is generated, and
wherein each input of the set of inputs identifies one of a data set, a query, and a function;
storing the result in a cache using the name generated from hashing the result;
receiving a request to access the result using the name;
retrieving the result from the cache using the name generated from hashing the result corresponding to the input; and
presenting the result in response to the request.

2. The method of claim 1, further comprising:
receiving, before calculating the result, an initial request to access a result;
calculating the result by evaluating an expression corresponding to the name; and
presenting the result in response to the initial request.

3. The method of claim 1, wherein calculating the result comprises:
locating the data set identified by a first input of the set of inputs;
applying the query, identified by a second input of the set of inputs, to the data set to generate a query result; and
applying the function, identified by a third input of the set of inputs, to the query result to generate the result.

4. The method of claim 1, further comprising:
hashing the set of inputs to generate the name from the set of inputs.

5. The method of claim 1, further comprising:
hashing a first input from the set of inputs to generate a first hash value;
hashing a second input from the set of inputs to generate a second hash value; and
joining the first hash value with the second hash value to generate the name.

6. The method of claim 1, further comprising:
digitally signing the result to generate the name.

7. The method of claim 1, further comprising:
hashing a subset of the set of inputs without hashing the result to generate a computable name of the function corresponding to an input of the subset of the set of inputs; and
applying the function using the computable name to generate a subsequent result.

8. The method of claim 1, further comprising:
hashing, to generate the name, the set of inputs, including a first input corresponding to one of the result and a partial result, without converting the other of the result and the partial result.

9. The method of claim 1, further comprising:
traversing a graph to identify a path corresponding to the set of inputs,
wherein each node of the graph corresponds to one of the data set, a partial result, and the result, and
wherein the graph is directed and acyclic and comprises an edge that identifies a function applied to a first node, of the graph, to generate the result corresponding to a second node of the graph; and
generating the name of the result using the path.

10. The method of claim 1, further comprising:
traversing a graph to identify a first path,
wherein the first path corresponds to the set of inputs and to the result, and
wherein the first path is different from a second path that corresponds to the result and does not correspond to the set of inputs; and
accessing the result in the cache using the first path.

11. The method of claim 1, further comprising:
adding, to a graph, a node corresponding to one of the result and a partial result after calculating the result and storing the result in the cache.

12. A system comprising:
a server comprising one or more processors and one or more memories; and
an application, executing on the one or more processors of the server, configured for:
calculating, by a result generator of the application, a result;
hashing, by the result generator, the result to generate a name of the result,
wherein the result is an input of a set of inputs from which the name is generated, and
wherein each input of the set of inputs identifies one of a data set, a query, and a function;
storing the result in a cache of the server using the name generated from hashing the result;
receiving, by the application, a request to access the result using the name;
retrieving the result from the cache using the name generated from hashing the result corresponding to the input; and
presenting the result in response to the request.

13. The system of claim 12, wherein the application is further configured for:
receiving, before calculating the result, an initial request to access a result;
calculating the result by evaluating an expression corresponding to the name; and
presenting the result in response to the initial request.

14. The system of claim 12, wherein calculating the result comprises:
locating the data set identified by a first input of the set of inputs;
applying the query, identified by a second input of the set of inputs, to the data set to generate a query result; and
applying the function, identified by a third input of the set of inputs, to the query result to generate the result.

15. The system of claim 12, wherein calculating the result comprises:
hashing the set of inputs to generate the name from the set of inputs.

16. The system of claim 12, wherein calculating the result comprises:
hashing a first input from the set of inputs to generate a first hash value;
hashing a second input from the set of inputs to generate a second hash value; and
joining the first hash value with the second hash value to generate the name.

17. The system of claim 12, wherein calculating the result comprises:
digitally signing the result to generate the name.

18. The system of claim 12, wherein calculating the result comprises:
hashing a subset of the set of inputs without hashing the result to generate a computable name of the function corresponding to an input of the subset of the set of inputs; and
applying the function using the computable name to generate a subsequent result.

19. The system of claim 12, wherein calculating the result comprises:
hashing, to generate the name, the set of inputs, including a first input corresponding to one of the result and a partial result, without converting the other of the result and the partial result.

20. A method comprising:
transmitting a request to access a result using a name,
wherein the result is calculated in response to a previous request,
wherein the result is hashed to generate the name,
wherein the result is an input of a set of inputs from which the name is generated,
wherein each input of the set of inputs identifies one of a data set, a query, and a function,
wherein the result is stored in a cache using the name generated from hashing the result, and
wherein, in response to the request, the result is retrieved from the cache using the name generated from hashing the result; and
receiving the result in response to the request.
